(19) United States
(12) Patent Application Publication
(10) Pub. No.: US 2007/0086550 A1
(43) Pub. Date: Apr. 19, 2007

(54) Receiving apparatus, mobile communication terminal, and communication system

(75) Inventor: Go Kaise, Yokosuka-shi (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/251,850

(22) Filed: Oct. 18, 2005

(51) Int. Cl. H04B 1/10

(52) U.S. Cl. 375/348; 375/350

(57) ABSTRACT

A receiving apparatus, a mobile communication terminal, and a communication system are provided that reduce power consumption and improve receiving performance even when changes occur in the receiving environment. Receiving apparatus 10, incorporated in a mobile communication terminal forming a communication system, has receiving quality threshold setter that receives as input a decoding determining signal outputted from error correction decoder 24 and outputs a threshold for use in determining receiving quality to receiving quality determiner 18. This receiving quality threshold setter 25 is able to adjust (change and correct) the threshold according to the result of error correction decoding outputted from error correction decoder 24. Based on the adjusted threshold, receiving quality determiner 18 determines receiving quality. Based on this determination result, controller 19 controls the operation of equalizer 22 or the operation of equalization and decoding processor 20.

### BACKGROUND OF THE INVENTION

1. Field of the Invention

The present invention relates to a receiving apparatus, a mobile communication terminal, and a communication system. More particularly, the present invention relates to a receiving apparatus that is incorporated in a digital mobile communication terminal, this digital mobile communication terminal, and a communication system including this digital mobile communication terminal.

2. Description of Related Art

Features of mobile communication include that multipaths exist due to the Doppler effect in transmission and reception while in motion, and blocking, reflection and diffraction by buildings. Multipaths cause inter-symbol interference between early waves and delayed waves of transmission data. To remove this inter-symbol interference from a receiving signal and extract original transmission data, the receiving apparatus of a mobile communication terminal needs an equalizer.

Recent mobile communication systems demand, higher transmission speeds and therefore the use of an equalizer is imperative. However, there is a technical problem that an equalizer consumes substantial power upon reception of a signal, and so the mobile communication terminal using a battery or equivalent power source cannot be used for a long time.

The following patent documents each disclose a method of reducing power consumption in a mobile terminal or in its receiving apparatus.

Japanese Patent Publication No.3257591 discloses a method which provides a receiving signal level measurer and determiner in a receiving circuit and operating an equalizer only when a decrease is detected in the receiving signal level.

Japanese Patent Publication No.2643614 discloses a method which stops an equalizer when the receiving signal level is less than a reference value.

Japanese Patent Publication No.3168610 discloses a method which operates an equalizer only upon receiving a transmission wave.

As shown in FIG. 7, the receiving circuit of this type has: antenna 1 that receives transmission data from the transmitting end; high frequency (RF) amplifier 2 that performs amplification and frequency conversion of the receiving signal; A/D converter 3 that performs analogue-to-digital conversion; demodulator 4 that performs demodulation; timing compensation circuit 5 that performs timing compensation of the receiving signal; equalizer 6 that cancels the inter-symbol interference caused by multipath fading; error correcting decoder 7 that performs error correction decoding of the receiving signal after equalization processing; and receiving level measurer and determiner 8 that measures quality of the receiving signal and determines the quality.

However, the above-described mobile terminal and its receiving apparatus do not take into consideration the following:

The above-described mobile terminal and its receiving apparatus cannot change the threshold for receiving quality, which refers to the receiving signal level, even when changes due to the influence of the propagation path occur in the receiving environment, including the inter-symbol interference intensity and high frequency channel quality (SNR: Signal to Noise Ratio). As a result, there is a likelihood of causing errors in the data after decoding and causing voice quality deterioration and packet loss. Furthermore, when changes occur in the receiving environment, the threshold for receiving quality cannot be changed in respect to the data that can be subjected to error correction, and, likewise, there is a likelihood of causing voice quality deterioration and packet loss. Consequently, the mobile terminal and its receiving apparatus have a likelihood of causing degradation in receiving performance.

### SUMMARY OF THE INVENTION

It is therefore an object of the present invention to provide a receiving apparatus, a mobile communication terminal and a communication system that reduce power consumption and that improve receiving performance when changes occur in the receiving environment.

In accordance with one aspect of the present invention, there is provided a configuration having: a measurer that measures receiving quality of a receiving signal; an equalizer that removes inter-symbol interference of the receiving signal; an error correction decoder that detects decoding errors in the receiving signal and performs error correction decoding according to decoding error detection results; a threshold setter that adjusts a threshold for use in determining the receiving quality based on a result of the error correction decoding; a receiving quality determiner that determines the receiving quality of the receiving signal based on the threshold; and a controller that controls an operation of the equalizer according to a determination result of the receiving quality.

In accordance with another aspect of the present invention, there is provided a configuration further having: a counter that counts the error correction decoding results; a table that stores a first threshold and a second threshold that are adjusted according to the receiving quality, and, in this configuration, the threshold setter changes the first threshold and the second threshold when the counter measures the error correction decoding result to be poor or good over a certain period of time; and the threshold setter changes the first threshold and the second threshold when the counter measures the error correction decoding results to be poor or good over a certain period of time, stops the operation of the equalizer and the error correction decoder when said receiving quality falls below the second threshold, and starts the operation of the equalizer and the error correction decoder when the counter measures the error correction decoding results to be good over a certain period of time.

### BRIEF DESCRIPTION OF THE DRAWINGS

The above and other objects and features of the invention will appear more fully hereinafter from a consideration of the following description taken in connection with the accompanying drawings, in which:

FIG. 1 is a block diagram showing a receiving apparatus incorporated in a mobile communication terminal in a communication system, according to an embodiment of the present invention;

FIG. 2(a)-(d) illustrate a method of inter-symbol interference intensity measurement in the receiving apparatus shown in FIG. 1;

FIG. 3 illustrates thresholds for receiving signal level in the receiving apparatus shown in FIG. 1;

FIG. 4 illustrates thresholds for inter-symbol interference intensity in the receiving apparatus shown in FIG. 1;

FIG. 5 illustrates thresholds for receiving quality in the receiving apparatus shown in FIG. 1;

FIG. 6 illustrates a method of threshold adjustment according to error correction decoding results in the receiving apparatus shown in FIG. 1; and

FIG. 7 is a block diagram showing a receiving apparatus of prior art.

### DESCRIPTION OF PREFERRED EMBODIMENTS

In a receiving apparatus, a mobile communication terminal and a communication system, it is a gist of the present invention to adjust (change or compensate) a threshold for use in determining receiving quality according to error correction decoding results, measure the receiving quality of a receiving signal based on the adjusted threshold, reflect the measurement result of the receiving quality upon receiving processing and operation, and control the operation of an equalizer that executes equalization processing.

Now, embodiments of the present invention will be described below in detail with reference to the accompanying drawings.

[Configuration of Receiving Apparatus, Mobile Communication Terminal and Communication System]

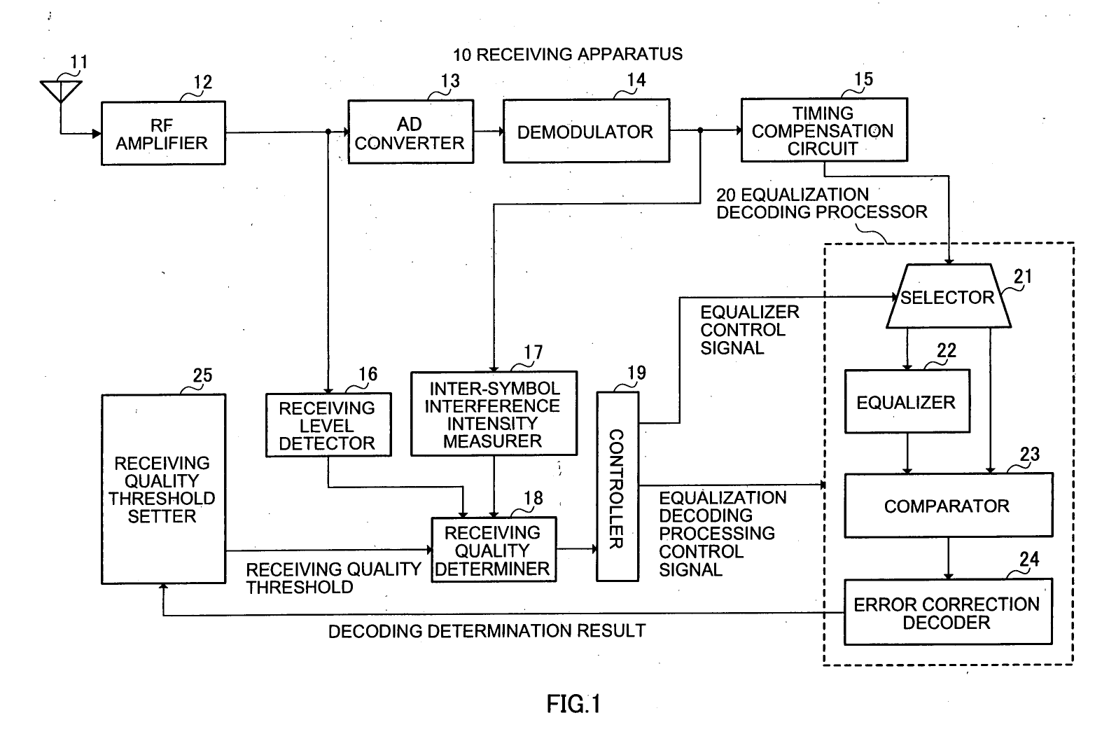

Receiving apparatus 10 of the present embodiment of the present invention shown in FIG. 1 is incorporated in a mobile communication terminal, and this communication terminal is part of a communication system. Receiving apparatus 10 has: a measurer that measures receiving quality of a receiving signal; equalizer 22 that cancels inter-symbol interference due to multipath fading from the receiving signal; error correction decoder 24 that detects decoding errors in the receiving signal and performs error correction decoding according to decoding error detection results; a threshold setter that sets thresholds for use in receiving quality determination according to error correction decoding results; a receiving quality determiner that determines the receiving quality of the receiving signal measured based on the threshold; and a controller that controls the operation of equalizer 22 according to receiving quality determination results.

In addition, receiving apparatus 10 has: antenna 11 that receives transmission data; a high frequency amplifier 12 that performs amplification an frequency conversion of the receiving signal; A/D converter 13 that performs analogue-to-digital conversion; demodulator 14 that performs demodulation processing of the receiving signal; and timing compensation circuit 15 that performs timing compensation of the receiving signal.

In this embodiment, the measurer in receiving apparatus 10 has: receiving level detector 16 that detects, in a simplified manner, the receiving level of a receiving signal outputted from high frequency amplifier 12 in a simplified manner; and inter-symbol interference intensity measurer 17 that measures, in a simplified manner, the inter-symbol interference intensity of the receiving signal outputted from demodulator 14. The receiving quality determiner has receiving quality determiner 18. This receiving quality determiner 18 receives as input the detection result in receiving level detector 16 and the measurement result in inter-symbol interference intensity measurer 17, receives as input the adjusted threshold from the threshold setter, and determines, based on this threshold, the receiving quality of the receiving signal level and the signal quality of the inter-symbol interference intensity.

In this embodiment, the threshold setter has receiving quality threshold setter 25. This receiving quality threshold setter is connected with error correction decoder 24, and error correction decoder 24 is configured to output a decoding determining signal that represents an error correction decoding result, to receiving quality threshold setter 25. In this embodiment, receiving quality threshold setter 25 has additional components that are not illustrated: a counter that counts the number of error correction decoding results (i.e. the number of decoding determining signals) and a table that stores a plurality of thresholds that are adjusted in accordance with receiving quality.

Now, the multiple thresholds stored in the table-include first-threshold α1 and second threshold α2 for determining the receiving quality level; first threshold β1 and second threshold β2 for determining inter-symbol interference intensity (these thresholds will be described later); and, in addition, thresholds that adjust (change or correct) determination levels according to changes in the receiving environment. Basically, receiving quality threshold measurer 25 adjusts the threshold in accordance with the decoding determining signal and outputs the adjusted threshold to receiving quality determiner 18.

The above-described counter incorporated in receiving quality threshold setter 25 is designed to count error correction decoding results and change the threshold, when the error correction decoding results are measured to be poor or good over a certain period of time. The counter has by no means to be provided in receiving quality threshold setter 25. For example, the counter may be incorporated in error correction decoder 24 or may be externally attached to error correction decoder 24 (incorporated in equalization and decoding processor 20), and output count results to receiving quality threshold setter 25. The operation of receiving quality threshold setter 25 and the threshold will be later described in detail.

Equalizer 22 and error correction decoder 24 form equalization and decoding processor 20. This equalization and decoding processor 20 has selector 21 and comparator 23. Selector 21 selects between outputting the receiving signal outputted from timing compensation circuit 15 to equalize 22 and directly outputting it to comparator 23. Comparator 23 compares the receiving signal which is outputted from equalizer 22 and from which inter-symbol interference is removed, and the receiving signal outputted from timing compensation circuit 15, and outputs the comparison result to error correction decoder 24.

In this embodiment, controller 19 forms the controller. Controller 19 outputs an equalization and decoding processing control signal that controls the operation of equalization and decoding processor 20 based on the determination result of the receiving quality of the receiving signal outputted from receiving quality determiner 18 and outputs an equalizer control signal that controls the operation of equalizer 22 that forms equalization and decoding processor 20.

[Operation of Receiving Apparatus]

Receiving apparatus 10 first distributes the receiving signal that is subjected to amplification and then frequency conversion in high frequency amplifier 12 to A/D converter 13 and receiving level detector 16 of the measurement means. Receiving level detector 16 performs receiving signal level measurement.

Meanwhile, A/D converter 13 performs analogue-to-digital conversion, and the receiving signal subjected to demodulation processing in demodulator 14 is inputted in inter-symbol interference intensity measurer 17, and, in this inter-symbol interference intensity measurer 17, the inter-symbol interference intensity is calculated by the following method.

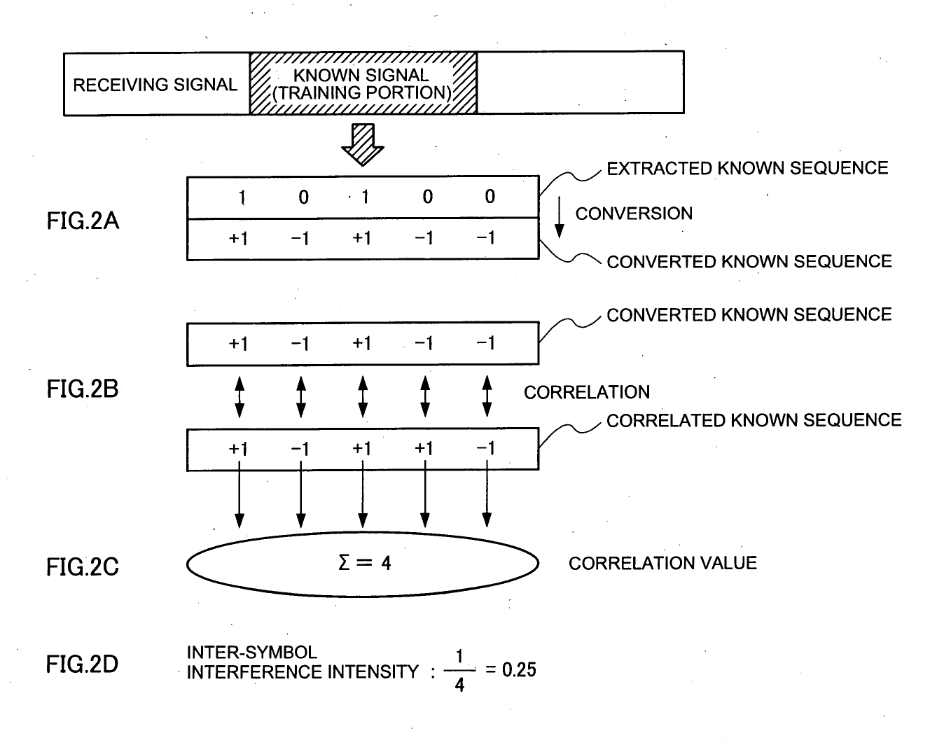

(1) A receiving signal (burst) that is received at receiving apparatus 10 includes a known sequence (i.e. training portion) for estimating the propagation path and channel upon reception, as shown in FIG. 2(a). The known sequence can be extracted from the receiving signal after demodulation processing in demodulator 14 (or after timing compensation in timing compensation circuit 15) (hereinafter this extracted known sequence will be referred to simply as “extracted known sequence”). Inter-symbol interference intensity measurer 17 has a table (e.g. a memory such as a RAM) that is not illustrated and that stores a preset known sequence for receiving apparatus 10 (hereinafter this stored known signal will be referred to simply as “stored known sequence”). The values are converted so as to establish correlation between the extracted known sequence and the stored known sequence. Here the extracted known sequence “1” is converted to “+1” and “0” is converted to “−1” (hereinafter this converted known signal will be referred to simply as “converted known sequence”).

(2) As shown in FIG. 2(b), the converted known sequence establishes correlation with the stored known sequence on a per symbol basis (hereinafter this correlated known sequence will be referred to simply as “correlated known sequence”). The correlation method employed herein is one that determines the product for every symbol.

(3) As shown in FIG. 2(c), in this correlated known signal sequence, a sum of the correlation values is calculated on a per symbol basis.

(4) As shown in FIG. 2(d), the inverse of the sum of the correlation values is determined and this inverse represents the inter-symbol interference intensity. For example, when the difference between the extracted known sequence and the stored known sequence is great, the inter-symbol interference intensity nears “1” (that is, the inter-symbol interference intensity increases). On the other hand, when the difference between the extracted known sequence and the stored known sequence is small, the inter-symbol interference intensity nears “0” (that is, the inter-symbol interference intensity decreases).

Next, the receiving signal level detected in receiving level detector 16 is outputted to receiving signal level or receiving quality determiner 18, and the inter-symbol interference intensity measured in inter-symbol interference intensity measurer 17 is outputted to receiving quality determiner 18. Receiving quality determiner 18 determines the receiving signal level and the inter-symbol interference intensity. The thresholds used to determine the receiving signal level and the inter-symbol interference intensity correspond to the equalization processing limit in equalizer 22 and are kept in receiving quality threshold setter 25.

The thresholds set in receiving quality threshold setter 25 include two types, namely the first threshold for determining whether the receiving signal has high enough receiving quality and does not require equalization processing, and the second threshold for determining whether the receiving signal has poor receiving quality and is unlikely to be successfully decoded even if equalization processing is applied.

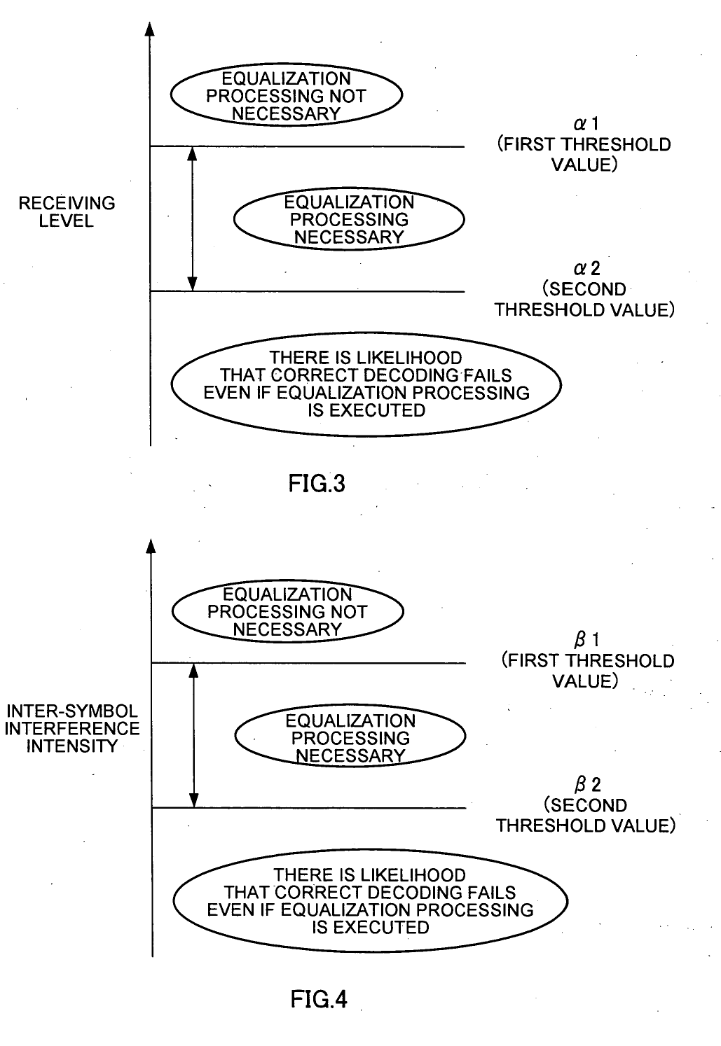

To be more specific, as shown in FIG. 3, the receiving signal level determination involves first threshold α1 for determining whether the receiving signal level has good enough receiving quality and does not require equalization processing and the second threshold α2 for determining whether the receiving signal has poor receiving quality and is unlikely to be successfully decoded even if equalization processing is applied. Let us now assume that the receiving signal level is x, and if this receiving signal level x is greater than first threshold α1 not taking into account the impact of inter-symbol interference intensity, equalization processing needs not be performed. On the other hand, when the receiving signal level x is less than threshold α2, there is a likelihood that correct decoding is still not possible even if equalization is performed.

In addition, referring to FIG. 4, in determining inter-symbol interference intensity, there are provided first threshold β1 for determining whether the receiving signal has low enough symbol interference intensity (i.e. good receiving quality) and does not require equalization processing, and second threshold β2 for determining whether the receiving signal has high inter-symbol interference intensity (i.e. poor receiving quality) and is unlikely to be successfully decoded even if equalization processing is applied. Let us now assume that the inter-symbol interference intensity is y, and if this inter-symbol interference intensity y is greater than first threshold β1 not taking into account the impact of the receiving signal level, equalization processing needs not be performed. On the other hand, when the inter-symbol interference intensity is less than second threshold β2, there is a likelihood that correct decoding is still not possible even if equalization processing is performed.

These fist thresholds α1 and β1 and second thresholds α2 and β2 can be adjusted (i.e. changed or corrected) in receiving signal threshold setter 25 based on the decoding determining signal outputted from error correction decoder 24.

There is no correlation between the receiving signal level and the inter-symbol interference intensity, and receiving quality determiner 18 determines receiving quality of a receiving signal in accordance with the mode configurations in FIG. 5 shown below as (a)-(c):

(a) Case where: receiving signal level x>first threshold α1 and inter-symbol interference intensity>first threshold β1

(b) Case where: receiving signal level x<first threshold α1 and inter-symbol interference intensity<first threshold β1

(c) Other cases where: above (a) and (b) do not apply.

Incidentally, in FIG. 5, region z1 represents the threshold bandwidth of the difference between first thresholds α1 and β1. Likewise, region z2 represents the threshold bandwidth of the difference between second thresholds β2 and β2.

Mode (a) refers to case where receiving quality determiner 18 determines that the receiving signal level is high and the inter-symbol interference intensity is low, that is, case where receiving quality determiner 18 determines that the receiving quality is high. In this case, equalization processing needs not be performed, and controller 19, shown in FIG. 1, outputs an equalizer control signal to selector 21. Selector 21 stops equalization processing by equalizer 22 in accordance with the equalization control signal and directly transmits the receiving signal after timing compensation to comparator 23.

Mode (b) refers to case where receiving quality determiner 18 determines that the receiving signal level is low and the inter-symbol interference intensity is high, that is, case where receiving quality determiner 18 determines that the receiving quality is low. In this case, likelihood is high that the correct decoding result cannot be obtained even if equalization processing is performed, and controller 19 outputs an equalization and decoding processing signal to equalization and decoding processor 20. Equalization and decoding processor 20 stops the operation of equalization and decoding processor 20 in response to the equalization and decoding control signal.

That is, equalization and decoding processor 20 stops all equalization and decoding processing. When all equalization and decoding processing stops, receiving apparatus 10 performs processing up to timing compensation circuit 15 and starts (or resumes) the equalization and decoding processing when the receiving signal level and the inter-symbol interference intensity exceed second threshold α2 and second threshold β2. The equalization and decoding processing are started by the equalization and decoding control signal outputted from controller 19 based on the receiving quality determination result outputted from receiving quality determiner 18.

Mode (C) refers to case where the receiving signal level and the inter-symbol interference intensity are at their normal level, that is, case where the receiving quality id determined to be at normal level. In this case, controller 19 outputs an equalizer control signal to selector 21 and outputs an equalization and decoding signal to equalization and decoding processor 20. Equalization and decoding processor 20 performs equalization and decoding processing in response to the equalization and decoding control signal. Selector 21 transmits the receiving signal after timing compensation to equalizer 22 in response to the equalizer control signal and equalizer 22 performs equalization processing.

In the above-described equalization and decoding processing in receiving apparatus 10, error correction decoder 24 shown in FIG. 1 constantly monitors the decoding result of certain symbols or the decoding result of the burst. The decoding result is outputted from error correction decoder 24 and receiving quality threshold setter 25 as the decoding determining signal. Here the error correction decoding result can in practice use the result of Viterbi decoding or the result of cyclic redundancy check.

The counter provided in receiving quality threshold setter 25 counts the number of times a decoding determining signal is received and, when correct decoding is not possible and this condition continues over certain symbols and burst, outputs a signal representing the count. In response to the output of the counter, receiving quality threshold setter 25 outputs thresholds that are stored separately in the table and are adequate for use in receiving quality determination, instead of first thresholds α1 and β1 and second thresholds α2 and β2 that are then in use in receiving quality determiner 18, to receiving quality determiner 18. That is, the thresholds can be adjusted in receiving quality determiner 18.

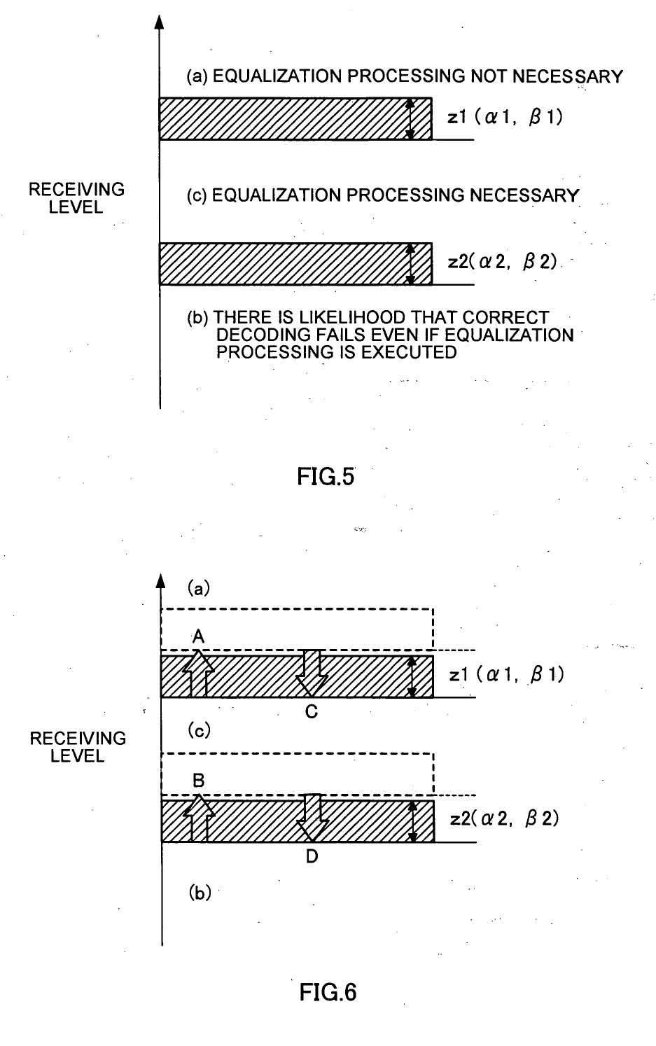

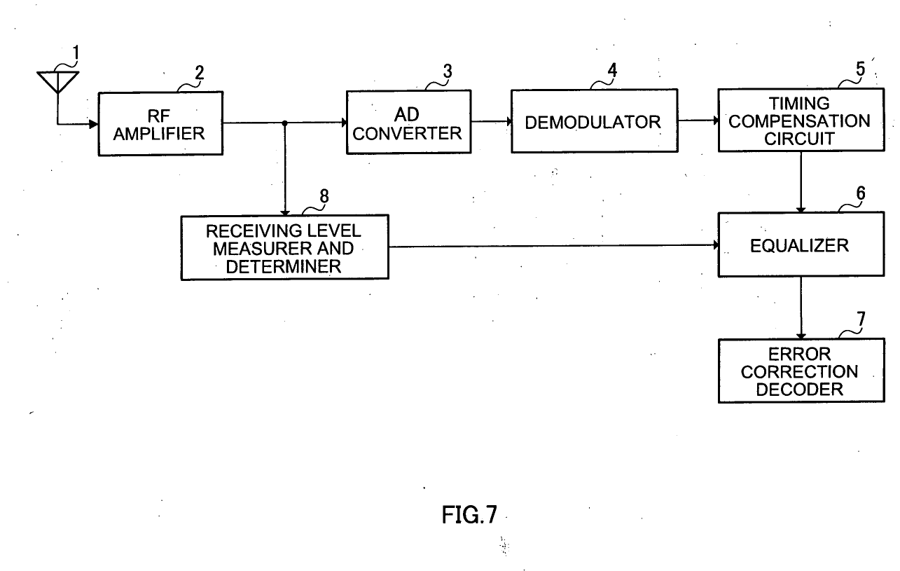

To be more specific, in the operation of receiving apparatus 10, cases occur where the receiving signal fulfills the reference value of receiving quality and yet cannot be decoded correctly due to changes in high frequency characteristics and changes in signal power to interference power ratio (i.e. CIR). For example, as shown in FIG. 6, when the receiving quality is in region (threshold bandwidth) z1 and cannot be correctly decoded, error correction decoder 24 outputs a decoding determining signal, and, in response to this decoding determining signal, receiving quality threshold setter 25 outputs a threshold that is adjusted to lift part z1, as shown by arrow A, to receiving quality determiner 18. As a result, equalizer 22 is able to execute equalization processing.

Also, when the receiving quality is in region z2 and the likelihood is high that correct decoding is still not possible even if equalization processing is performed, receiving quality threshold setter 25 outputs a threshold that is adjusted to lift part z2, as shown by arrow B, to receiving quality determiner 18. As a result, it is possible not to execute equalization and decoding processing.

On the other hand, there are times when the signal power to interference power ratio improves and a receiving signal does not require equalization processing. In this case, selector 2 sorts receiving signals after timing compensation and comparator 23 compares a receiving signal that is subjected to equalization processing in equalizer 22 and a receiving signal that skips equalizer 22. As a result, if correct decoding is determined to be possible without equalization processing, error correction decoder 24 outputs a decoding determining signal to receiving quality threshold setter 25, and, in response to this decoding determining signal, receiving quality threshold setter 25 outputs a threshold shown by arrow C that is adjusted to lower region z1, to receiving quality determiner 18. As a result, it is possible not to perform equalization processing by equalizer 22.

Likewise, when the receiving quality is low and the equalization and decoding processor 20 has stopped its operation, the equalization and decoding processing resumes, temporarily, on a regular basis. If, during this regular equalization and decoding processing, a result is obtained over a certain number of times that a receiving signal is correctly decoded, a threshold shown by arrow D that is adjusted to lower region z2, is outputted to receiving quality determiner 18. As a result, the equalization and decoding processing by equalization and decoding processor 20 is made possible.

Thus, according to the present embodiment, error correction decoder 24 performs decoding processing of a receiving signal after equalization processing in equalizer 22 and outputs the error correction decoding result to receiving quality threshold setter 25, and this receiving quality threshold setter 25 is able to adjust (change or compensate) the threshold for use in determining the receiving quality according to the error correction decoding result. When a receiving signal fulfilling certain standard produces error after decoding due to change in the receiving environment, it is still possible to determine the receiving quality based on the threshold adjusted in receiving quality determiner 18, so that the receiving performance of receiving apparatus 10 can be improved. Improving the receiving performance of receiving apparatus 10 leads to improved receiving performance of the mobile communication terminal incorporating receiving apparatus 10, consequently improving the overall receiving performance of the communication system.

In addition, the operation of equalizer 22 is controlled according to the adjusted threshold. To be more specific, when a receiving signal has high receiving quality and does not require equalization processing or when a receiving signal cannot be correctly decoded even when equalization processing is performed, control is executed to stop equalizer 22, and, D when a receiving signal has low receiving quality and requires equalization processing, control is executed to start equalizer 22. Power consumption can be reduced thus. In addition, the thresholds for use in determining receiving quality can be adjusted, making it possible to further improve receiving performance and further decrease power consumption.

As described above, the present invention provides a receiving apparatus, a mobile communication terminal, and a communication system that can reduce power consumption and that can improve receiving performance when there are changes in the receiving environment.

In accordance with one aspect of the present invention, the receiving apparatus of the present invention employs a configuration having: a measurer that measures receiving quality of a receiving signal; an equalizer that removes inter-symbol interference of the receiving signal; an error correction decoder that detects decoding errors in the receiving signal and performs error correction decoding according to decoding error detection results; a threshold setter that adjusts a threshold for use in determining the receiving quality based on a result of the error correction decoding; a receiving quality determiner that determines the receiving quality of the receiving signal based on the threshold; and a controller that controls an operation of the equalizer according to a determination result of the receiving quality.

According to this configuration, the error correcting decoder, which performs decoding processing of a receiving signal after equalization processing in the equalizer, outputs the error correction decoding result to the threshold setter, and this threshold setter adjusts (changes or compensates) the threshold for use in determining receiving quality based on the error correction decoding result. Even when the receiving signal fulfilling certain standard produces an error after decoding due to changes in the receiving environment, the receiving quality determiner is able to determine the receiving quality of the receiving signal based on the adjusted threshold, thereby improving receiving performance. In addition, the operation of the equalizer is controlled according to the adjusted threshold. To be more specific, when a receiving signal has high receiving quality and does not require equalization processing or when a receiving signal cannot be correctly decoded even when equalization processing is performed, control is executed to stop the equalizer, and, when a receiving signal has low receiving quality and requires equalization processing, control is executed to start the equalizer. Power consumption can be reduced thus.

In accordance with one aspect of the present invention, the receiving apparatus of the present invention employs a configuration further having: a counter that counts error correction decoding results; and a table that stores a plurality of thresholds that are subject to adjustment according to the receiving quality, and, in this configuration, the threshold setter changes the threshold when the error correction decoding results are measured by the counter to be poor or good over a certain time.

In accordance with one aspect of the present invention, the receiving apparatus of the present invention employs a configuration in which a result of error correction decoding in the error correction decoder comprises a Viterbi decoding result and a cyclical redundancy check (CRC) result.

In accordance with one aspect of the present invention, the receiving apparatus of the present invention employs a configuration further having: a comparator that compares the receiving signal after the equalization processing in the equalizer and the receiving signal prior to the equalization processing, and, in this configuration, the threshold setter adjusts the threshold for use in determining the receiving signal based on a result of comparison in the comparator.

In accordance with one aspect of the present invention, the receiving apparatus of the present invention employs a configuration in which the threshold setter adjusts a first threshold and a second threshold; and the controller executes control that stops an operation of the equalizer when the receiving quality in the receiving quality determiner is greater than the first threshold value and stops the operation of the operation of the equalizer and the error correction decoder when the receiving quality falls below the second threshold.

In accordance with one aspect of the present invention, the receiving apparatus of the present invention employs a configuration further having: a counter that counts the error correction decoding results; and a table that stores a first threshold and a second threshold that are adjusted according to the receiving quality, and, in this configuration, the threshold setter changes the first threshold and the second threshold when the counter measures the error correction decoding result to be poor or good over a certain period of time; and the threshold setter changes the first threshold and the second threshold when the counter measures the error correction decoding results to be poor or good over a certain period of time, stops the operation of the equalizer and the error correction decoder when the receiving quality falls below the second threshold, and starts the operation of the equalizer and the error correction decoder when the counter measures the error correction decoding results to be good over a certain period of time.

In accordance with an aspect of the present invention, the mobile communication terminal of the present invention employs a configuration having the above-described receiving apparatus.

In accordance with an aspect of the present invention, the communication system of the present invention employs a configuration having the above-described receiving apparatus.

Thus, the receiving apparatus, mobile communication terminal, and communication system of the present invention each have the advantage of reducing power consumption and improving receiving performance even when changes occur in the receiving environment, and are applicable to apparatus and systems having equivalent processing circuits.

The present invention is by no means limited to the above described embodiments, and various variations and modifications may be possible without departing from the scope of the present invention.

This application is based on Japanese Patent Application No.2004-132990, filed Apr. 28, 2004, entire content of which is expressly incorporated by reference herein.

What is claimed is:

1. A receiving apparatus comprising:
a measurer that measures receiving quality of a receiving signal;
an equalizer that removes inter-symbol interference of the receiving signal;
an error correction decoder that detects decoding errors in the receiving signal and performs error correction decoding according to decoding error detection results;
a threshold setter that adjusts a threshold for use in determining the receiving quality based on a result of the error correction decoding;
a receiving quality determiner that determines the receiving quality of the receiving signal based on the threshold; and
a controller that controls an operation of the equalizer according to a determination result of the receiving quality.

2. The apparatus of claim 1, further comprising:
a counter that counts error correction decoding results; and
a table that stores a plurality of thresholds that are subject to adjustment according to the receiving quality,
wherein the threshold setter changes the threshold when the error correction decoding results are measured by the counter to be poor or good over a certain time.

3. The apparatus of claim 1, wherein a result of error correction decoding in the error correction decoder comprises a Viterbi decoding result and a cyclical redundancy check result.

4. The apparatus of claim 1, further comprising a comparator that compares the receiving signal after the equalization processing in the equalizer and said receiving signal prior to said equalization processing,
wherein the threshold setter adjusts the threshold for use in determining the receiving signal based on a result of comparison in the comparator.

5. The apparatus of claim 1, wherein:
the threshold setter adjusts a first threshold and a second threshold; and
the controller executes control that stops an operation of the equalizer when the receiving quality in the receiving quality determiner is greater than the first threshold value and stops the operation of the operation of the equalizer and the error correction decoder when the said receiving quality falls below the second threshold.

6. The apparatus of claim 1, wherein the threshold setter comprises:
a counter that counts the error correction decoding results;
a table that stores a first threshold and a second threshold that are adjusted according to the receiving quality, wherein:
the threshold setter changes the first threshold and the second threshold when the counter measures the error correction decoding result to be poor or good over a certain period of time; and
the threshold setter changes the first threshold and the second threshold when the countermeasures the error correction decoding results to be poor or good over a certain period of time, stops the operation of the equalizer and the error correction decoder when said receiving quality falls below the second threshold, and starts the operation of the equalizer and the error correction decoder when the counter measures the error correction decoding results to be good over a certain period of time.

7. A mobile communication terminal comprising the receiving apparatus of claim 1.

8. A communication system of comprising the receiving apparatus of claim 1.
